(19) United States
(12) Patent Application Publication
(10) Pub. No.: US 2013/0318481 A1
(43) Pub. Date: Nov. 28, 2013

(54) CONFIGURING USER INTERFACE ELEMENT LABELS

(71) Applicant: SESHATALPASAI MADALA, Bangalore (IN)

(72) Inventor: SESHATALPASAI MADALA, Bangalore (IN)

(21) Appl. No.: 13/480,476

(22) Filed: May 25, 2012

(51) Int. Cl. G06F 3/048

(52) U.S. Cl. 715/854

(57) ABSTRACT

In one embodiment, a request to render a UI element label is received. Further, a user specific UI display specification for the UI element label specifying a display configuration of the UI element label at a plurality of hierarchical software component levels is retrieved. Furthermore, a current hierarchical level of software component associated with the request displaying the UI element label is determined. Based on determining the current hierarchical level of software component, the UI element label is displayed according to the user specific UI display specification.

### FIELD

Embodiments generally relate to computer generated user interfaces and more particularly to methods and systems to configure user interface element labels.

### BACKGROUND

User interface (UI) includes UI elements such as text, tables, dropdown lists and pop up messages that help a user to view or input data to a software application. Many a time, users may have their own preferences regarding representation of UI element labels. Further, due to globalization, the UI element labels are translated to other languages and users may prefer to change the terminology to suit their nativity. For example, consider a UI that displays details of an employee such as ‘name’ and ‘employee identification number’ in a table with each of these attributes of the employee as a column. A user may prefer to see the details as ‘name’ and ‘identifier number’ whereas another user may prefer to see the details as ‘name’ and ‘employee identifier’. This requires configuration to the UI element labels according to the preferences of the users. Typically, configuring the UI element labels (e.g., from ‘employee identification number’ to ‘identifier number’ and ‘employee identifier’) requires development of a new software component or a patch and providing it along with a new version of the software application to the user, which involves significant time, effort and cost.

### BRIEF DESCRIPTION OF THE DRAWINGS

The claims set forth the embodiments with particularity. The embodiments are illustrated by the way of examples and not by the way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating configuring UI element labels, according to an embodiment.

FIG. 2 is a block diagram illustrating hierarchical software component levels, according to an embodiment.

FIG. 3 is a flow diagram illustrating a method to configure a UI element label, according to an embodiment.

FIG. 4 shows an exemplary UI illustrating a UI element label to be configured, according to an embodiment.

FIG. 5 is an exemplary online text repository (OTR) UI element display specification table specific to a user, according to an embodiment.

FIG. 6 shows an exemplary UI illustrating a configured UI element label corresponding to the UI element label of FIG. 4, according to an embodiment.

FIG. 7 is an exemplary OTR UI element display specification table specific to another user, according to an embodiment.

FIG. 8 shows an exemplary UI illustrating a configured UI element label corresponding to the UI element label of FIG. 4, according to an embodiment.

FIG. 9 shows an exemplary UI illustrating configuration of a UI element display specification table, according to an embodiment.

FIG. 10 is a block diagram of an exemplary computer system, according to an embodiment.

### DETAILED DESCRIPTION

Embodiments of techniques to configure UI element labels are described herein. According to various embodiments, UI corresponding to an application is an interface that displays data and/or accepts input. UI includes one or more UI elements such as, but not limited to text, tables, dropdown lists and pop up messages and associated labels. Further, the UI element labels may be grouped based on their type. For example, the types of the UI element label may include a plain text (e.g., SAP® an online text repository (OTR) text), a table element (e.g., SAP® data element) and an alert message (e.g., SAP® T100 message).

According to one embodiment, the UI element label is configured to include a user specific UI specification without redeveloping the UI. The configuration is performed by accessing an associated UI element display specification table specific to a user. The UI element display specification table includes user specific UI specification. Further, the user specific UI specification may include user specific element label corresponding to the UI element label and a plurality of hierarchical software component levels at which the UI element label is configured. During runtime, the UI element display specification table corresponding to the UI element label is accessed and the UI element label is configured to include user specific element label at the plurality of hierarchical software component levels. This provides the user the flexibility of configuring the UI element labels in the UI, which eliminates the need to redesign and redevelop the UI and therefore, minimizes time, effort and cost.

In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

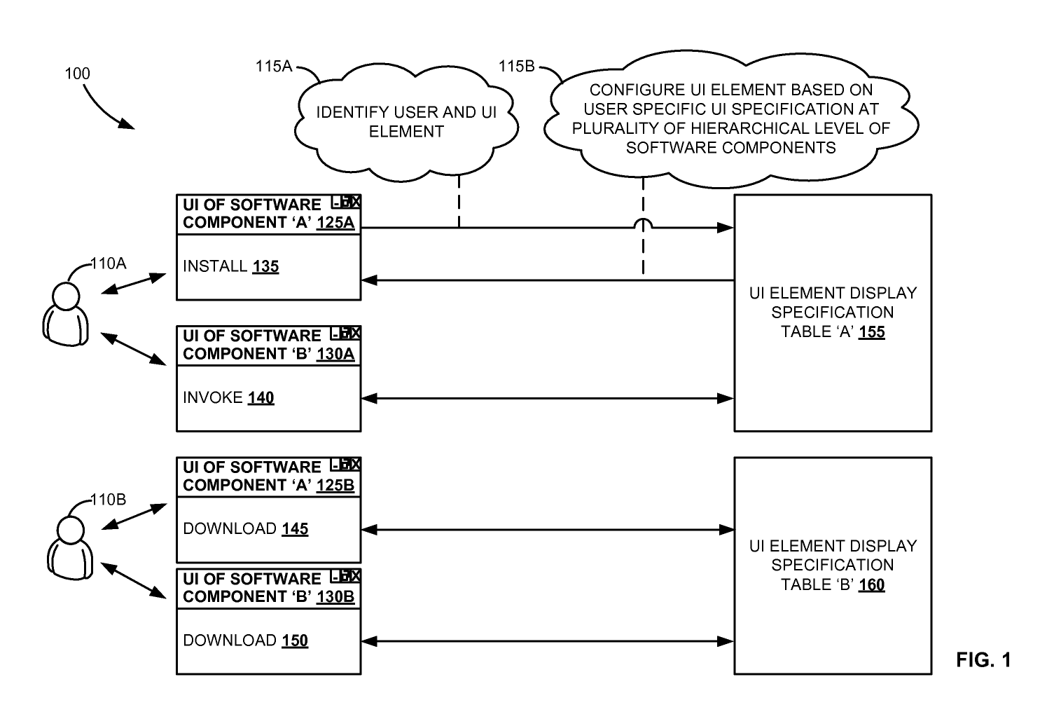

FIG. 1 is a block diagram 100 illustrating configuring UI element labels, according to an embodiment. Users (e.g., 110A and 110B) request to render a UI (e.g., 125A, 130A, 125B and 130B). The UI may include one or more UI element labels. For example, when the users (e.g., 110A and 110B) request to render the UI of software component ‘A’, an associated UI element display specification table (e.g. 155 and 160) is accessed based on identifying the users (e.g., 110A and 110B) and the UI element label. The UI element display specification table ‘A’ 155 may be associated with the user 110A for the UI element label of the UI of software component ‘A’ and the UI element display specification table T 160 may be associated with the user 110B for the UI element label of the UI of software component ‘A’.

Further, user specific UI display specification for the UI element label of the UI is extracted from the UI element display specification table (e.g. 155 and 160) based on identifying the user and the UI element label 115A. In one exemplary embodiment, the user 110A may prefer to view a UI element labeled as ‘install’ 135 in the software component ‘A’ and labeled as ‘invoke’ 140 in the software component T. Accordingly, when the user 110A requests to render the UI of software component ‘A’, the UI element label ‘install’ 135 is displayed and when the user 110A requests to render the UI of software component ‘B’, the UI element is labeled as ‘invoke’ 140 using the UI element display specification table 155. Similarly, another user 110B may prefer to view the UI element label as ‘download’ (e.g., 145 and 150) in both the software component ‘A’ and the software component ‘B’. Accordingly, when another user 110B requests to render the same UI of software component ‘A’, the UI element is labeled as ‘download’ 145 and when the user 110B requests to render the UI of software component ‘B’, the UI element is again labeled as ‘download’ 150 using the UI element display specification table 160. Further, the user specific UI specifications are stored in the associated UI element display specification tables. The UI element display specification table (e.g. 155 and 160) is specific to the users (e.g., 110A and 110B).

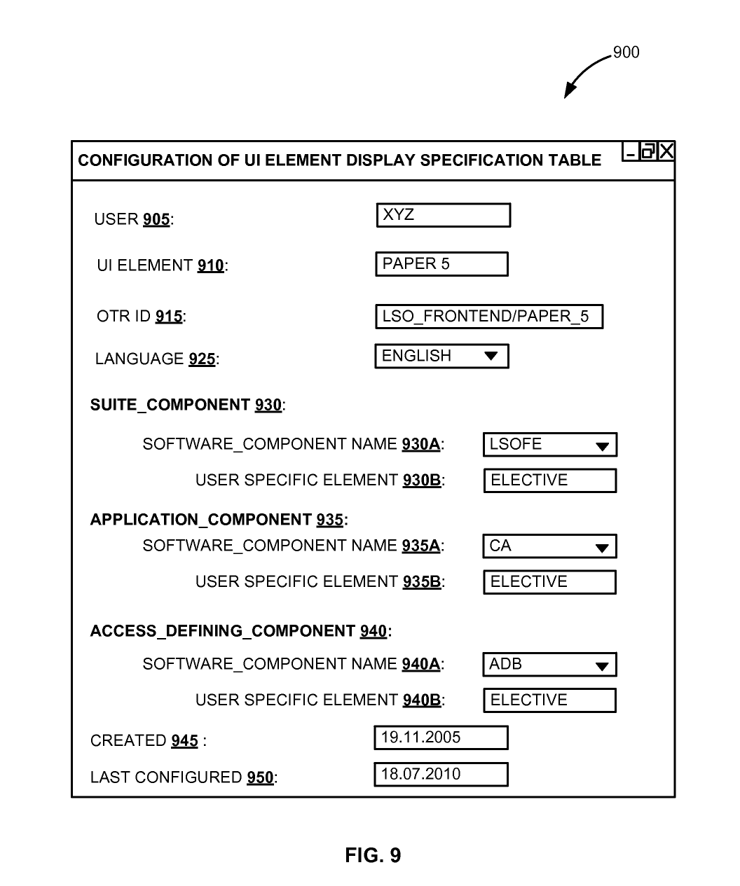

In one embodiment, different UI element display specification tables are created for different users and/or group of users. Further, an authorized person is provided an option to create or modify or configure the UI element display specification table. The authorized person may be, but is not limited to an administrator of an enterprise and a user of the UI having the authority to assign access control in an enterprise. Creating or modifying or configuring the UI element display specification table 125 is described in greater detail in FIG. 9.

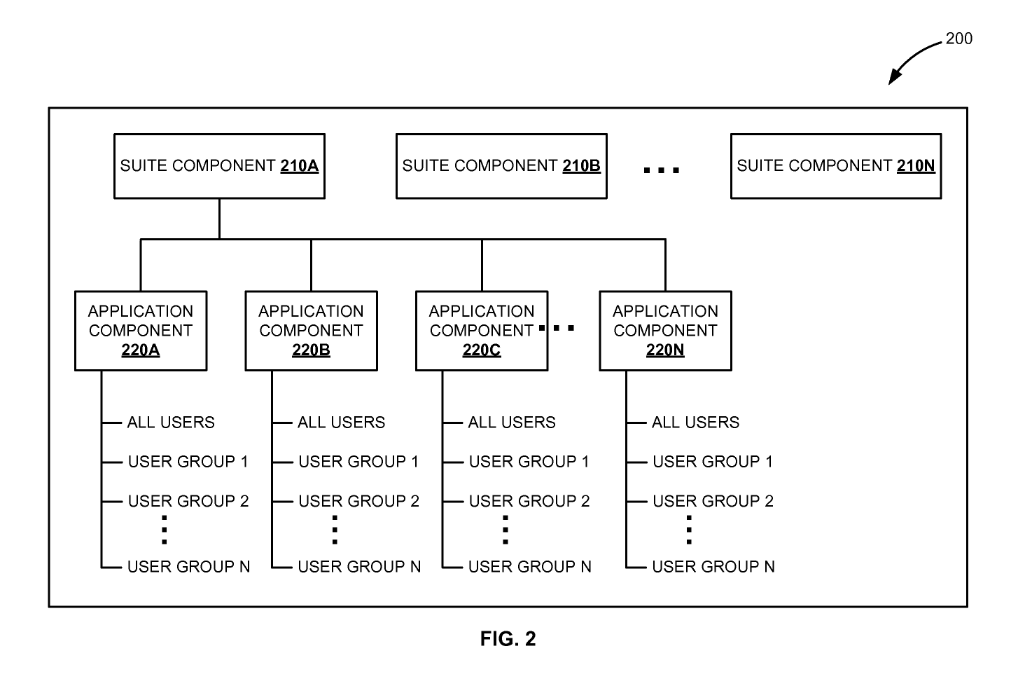

In one embodiment, the UI element labels are configured to include corresponding user specific element labels in a plurality of hierarchical software component levels 115B. For example, according to one embodiment the display specification for a UI element label could be based not only on the user's identity but also on a level of software component being used in a hierarchy of software component levels. The hierarchical software component levels may include, but are not limited to a suite component level, an application component level and an access defining component level, for instance. For example, SAP® ERP suite is a suite application that is further broken down into lower application component levels such as a learning application, a finance application. Further, the access defining component level defines user groups having the different access level in the application component. In one embodiment, the authorized person is provided an option to select the level of software component hierarchy at which the UI element label is configured. The selection of the hierarchical software component levels is stored in the UI element display specification table. The hierarchical software component levels are described in greater detail in FIG. 2 and selection of the level of component is described with an example in FIG. 9.

FIG. 2 is a block diagram 200 illustrating hierarchical software component levels, according to an embodiment. The hierarchical software component levels, may include, but are not limited to a suite component level (e.g., suite components 210A to 210N), an application component level (e.g., application components 220A to 220N) and an access defining component level (e.g., all users and user group 1 to N corresponding to the application components 220A to 220N). A suite component (e.g., suite components 210A to 210N) may include a plurality of applications (e.g., the application components 220A to 220N). For example, the suite component corresponding to an enterprise resource planning may include applications such as, but not limited to, a finance application, sales and service application and a learning application. Further, an application component (e.g., the application components 220A to 220N) may include an application such as, but not limited to the learning application, the finance application and a user relationship management application. Further, the access defining component may refer to one or more objects (e.g., all users and user groups 1 to N corresponding to the application components 220A to 220N) associated with the application component. In other words, the one or more objects may be developed for different users in an enterprise. For example, a specific UI with limited access to data for employees and a specific UI with all access to data for an administrator may be created by developing specific access defining components (e.g., all users and user group 1 to N corresponding to the application components 220A to 220N). In one embodiment, an authorized person is provided an option to select the level of component hierarchy at which the UI element label is configured for a specific user (e.g., all users and user group 1 to N corresponding to the application components 220A to 220N), which is described in greater detail in FIG. 9.

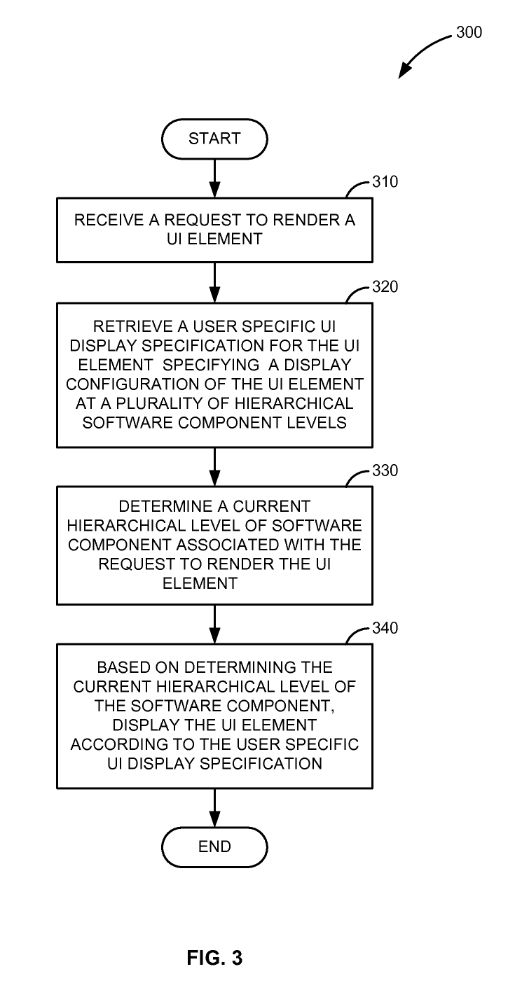

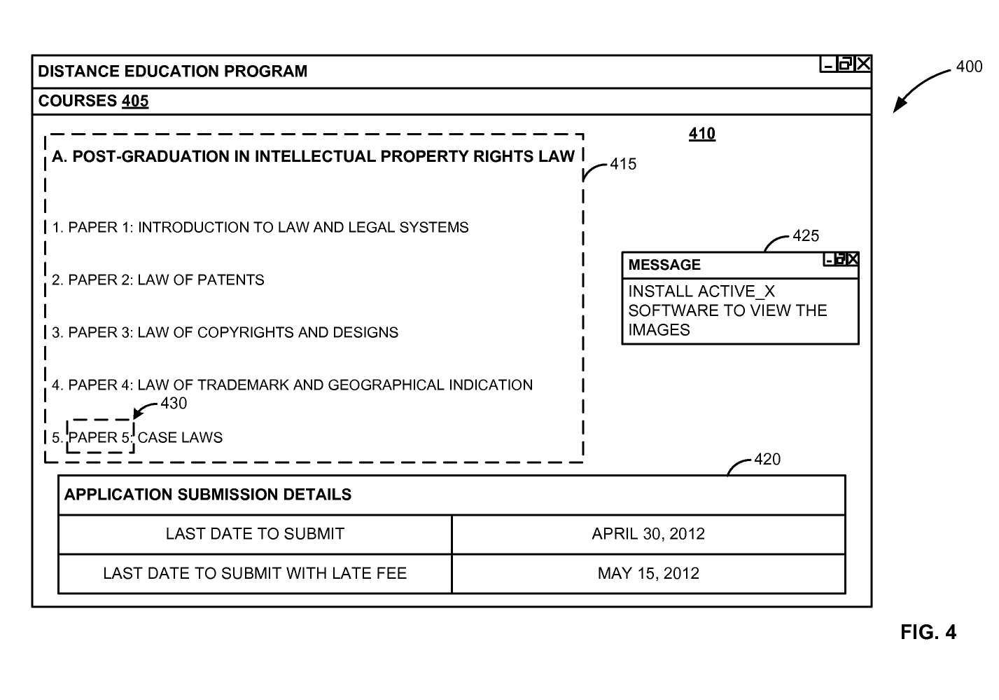

FIG. 3 is a flow diagram 300 illustrating a method to configure a UI element label, according to an embodiment. At step 310, a request to render a UI element label is received. The UI element labels may be, but are not limited to labels of text, table, dropdown list and pop up message on a UI associated with an application. In one exemplary embodiment, the UI element labels may be grouped based on the type of the UI element labels such as a plain text (e.g., SAP® an online text repository (OTR) text), a table element (e.g., SAP® data element) and an alert message (e.g., SAP® T100 message). The OTR text may include simple or plain text on the UI. Data elements may include table content on the UI. Further, the T100 messages may include pop up alert messages on the UI. The UI element label is described in greater detail with an example in FIG. 4.

At step 320, a user specific UI display specification for the UI element label specifying a display configuration (e.g., a user specific element label) of the UI element label at a plurality of hierarchical software component levels are retrieved. In one embodiment, the user specific UI display specification is stored in a UI element display specification table specific to a user. Further, the UI element display specification table is stored in an in-memory computing database. The user specific element label corresponding to the UI element label is retrieved from an associated UI element display specification table using a unique identifier of the UI element label. Further, the unique identifier of the UI element label is defined by a type of the UI element label including one of the OTR text, the data element and the alert message. Also, UI element display specification tables are stored based on the type of the UI element labels. For example, an OTR text element display specification table associated with the OTR text, data element display specification table associated with data elements and alert message element display specification table associated with the alert messages, which are specific to the user and the UI element label are stored. Further, the associated UI element display specification table is identified using a unique identifier of the UI element label. The unique identifier of the UI element label is described with an example in FIG. 4.

At step 330, a current hierarchy level of software component associated with the request displaying the UI element label is determined. The current hierarchy level of software component associated with the request is stored in the UI element display specification table defining the user specific UI display specification. In one embodiment, the user specific UI display specification is provided by an authorized person. Also, the authorized person is provided an option to select the hierarchy level of software components at which the UI element label is to be configured (described with an example in FIG. 9) for a specific user. The level of component hierarchy may include, but is not limited to a suite component level, an application component level and an access defining component level as described in FIG. 2.

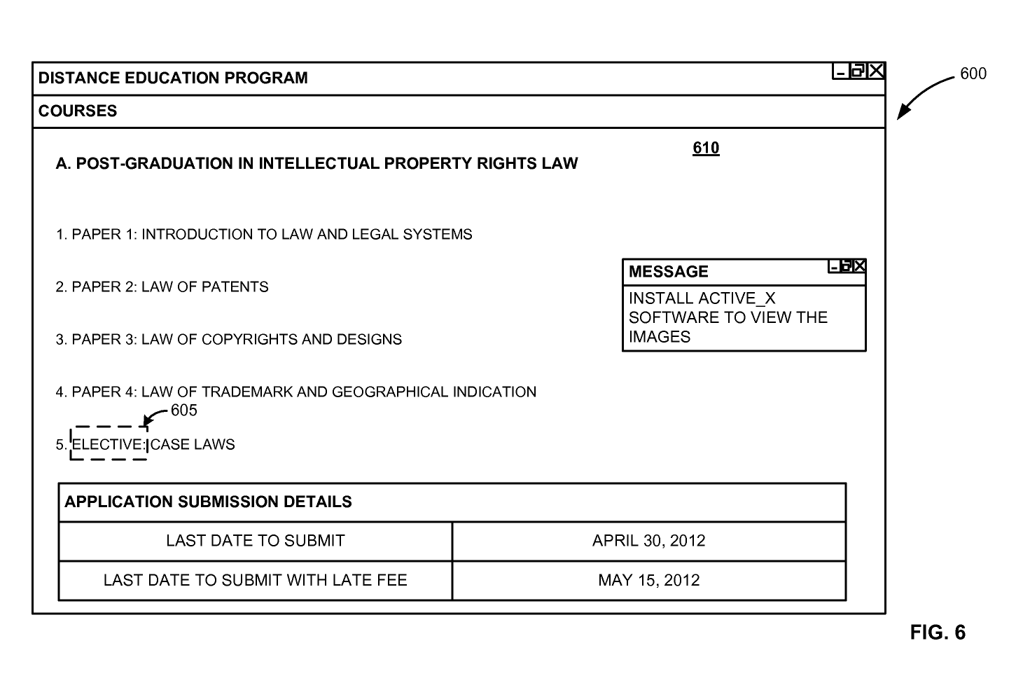

At step 340, based on determining the current hierarchical level of the software components (e.g., suite component level, application component level and access defining component level), the UI element label is displayed according to the user specific UI display specification. In other words, the UI element label is configured with the user specific element label in the current hierarchical level of software component (e.g., suite component level, application component level and access defining component level). In one embodiment, the configured UI element label is rendered on a computer generated user interface. An example of the configured UI element label is described with an example in FIG. 6.

FIG. 4 shows an exemplary UI 400 illustrating a UI element label to be configured, according to an embodiment. The UI 400 refers to a distance education program displaying offered courses 405. The offered courses 405 are displayed in a portion (e.g., 410) of the UI 400. Further, the portion 410 includes online text repository text (e.g., 415), data elements (e.g., 420) and alert message (e.g., 425).

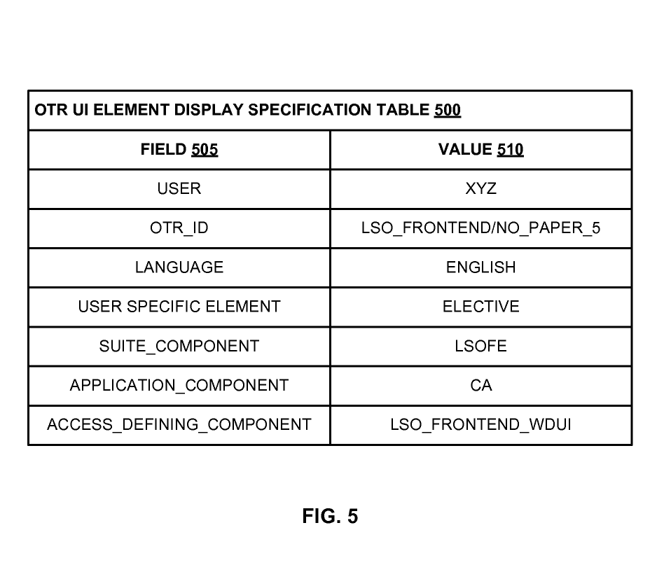

In one exemplary embodiment, a user prefers to configure a UI element label ‘paper 5’ 430. During runtime, display configuration of the UI element label ‘paper 5’ 430 (e.g., a user specific element label corresponding to the UI element label ‘paper 5’ 430) is retrieved. The user specific element label is retrieved from an associated UI element display specification table using a unique identifier of the UI element label ‘paper 5’ 430. The associated UI element display specification table is specific to the user. Further, the unique identifier of the UI element label ‘paper 5’ 430 is determined by a type of the UI element label. For example, the type of the UI element label ‘paper 5’ 430 is online text repository (OTR) text. Thereby, the user specific element label corresponding to the UI element label ‘paper 5’ is retrieved from an OTR UI element display specification table specific to the user. An exemplary OTR UI element display specification table specific to the user (e.g., XYZ) is shown in FIG. 5.

According to FIG. 5, the OTR UI element display specification table 500 may include columns for depicting field 505 and corresponding value 510. The field 505 may include, but is not limited to user name (e.g., XYZ), OTR ID (e.g., OTR ID corresponding to the UI element label ‘paper 5’ is LSO_FRONTEND/NO_PAPER_5), language (e.g., English), a user specific element label (e.g., the user specific element label ‘elective’ corresponding to the UI element label ‘paper 5’), a suite component (e.g., LSOFE), one or more application components (e.g., CA) and one or more access defining components (e.g., LSO_FRONTEND_WDUI). Further, the user specific element label (e.g., elective) and the level of component hierarchy at which the UI element label is to be configured (e.g., the suite component, the application component and the access defining components) specific to the user are provided by an authorized person (described with an example in FIG. 9).

In the example, the OTR UI element display specification table 500 is accessed during runtime to retrieve the user specific element label (e.g., ‘elective’) corresponding to the UI element label (e.g., ‘paper 5’ 430) when the user (e.g., XYZ) request to render the UI. Further, the UI element label ‘paper 5’ 430 is configured in the suite component ‘LSOFE’, the application component ‘CA’ and the development component ‘LSO_FRONTEND_WDUI’. The UI 400 with configured UI element label ‘paper 5’ 430 is depicted in FIG. 6. In one exemplary embodiment, when the user specific element label is not present in the UI element display specification table, the standard elements (e.g., the UI element label) are displayed without configuration.

FIG. 6 shows an exemplary user interface 600 illustrating a configured UI element label corresponding to the UI element label of FIG. 4, according to an embodiment. During runtime, an associated UI element display specification table (e.g., OTR element table for the UI element label ‘paper 5’ associated with the user XYZ of FIG. 5) is accessed and accordingly the UI element label ‘paper 5’ is configured to user specific element label ‘elective’ 605 in a portion 610 when the user XYZ requests to render the UI. Further, the UI element label ‘paper 5’ is configured in a suite component ‘LSOFE’, an application component ‘CA’ and a development component ‘LSO_FRONTEND_WDUI’ as per an OTR UI element display specification table 500 of FIG. 5.

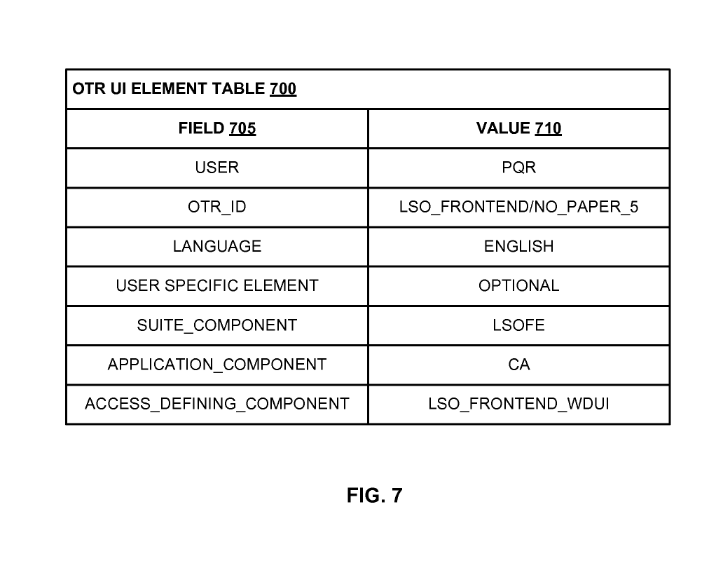

FIG. 7 is an exemplary OTR UI element display specification table 700 specific to another user (e.g., PQR), according to an embodiment. The OTR UI element display specification table 700 may include columns for depicting field 705 and corresponding value 710. The field 705 may include, but not limited to user name (e.g., PQR), OTR ID (e.g., OTR ID corresponding to the UI element label ‘paper 5’ is LSO_FRONTEND/NO_PAPER_5), language (e.g., English), a user specific element label (e.g., the user specific element label ‘optional’ corresponding to the UI element label ‘paper 5’), a suite component (e.g., LSOFE), one or more application components (e.g., CA) and one or more access defining components (e.g., LSO_FRONTEND_WDUI). In one embodiment, the UI element display specification table is specific to the user (e.g., PQR). Further, the user specific element label (e.g., optional) and the level of component hierarchy at which the UI element label is to be configured (e.g., the suite component, the application component and the access defining components) specific to the user (e.g., PQR) are provided by an authorized person (described with an example in FIG. 9).

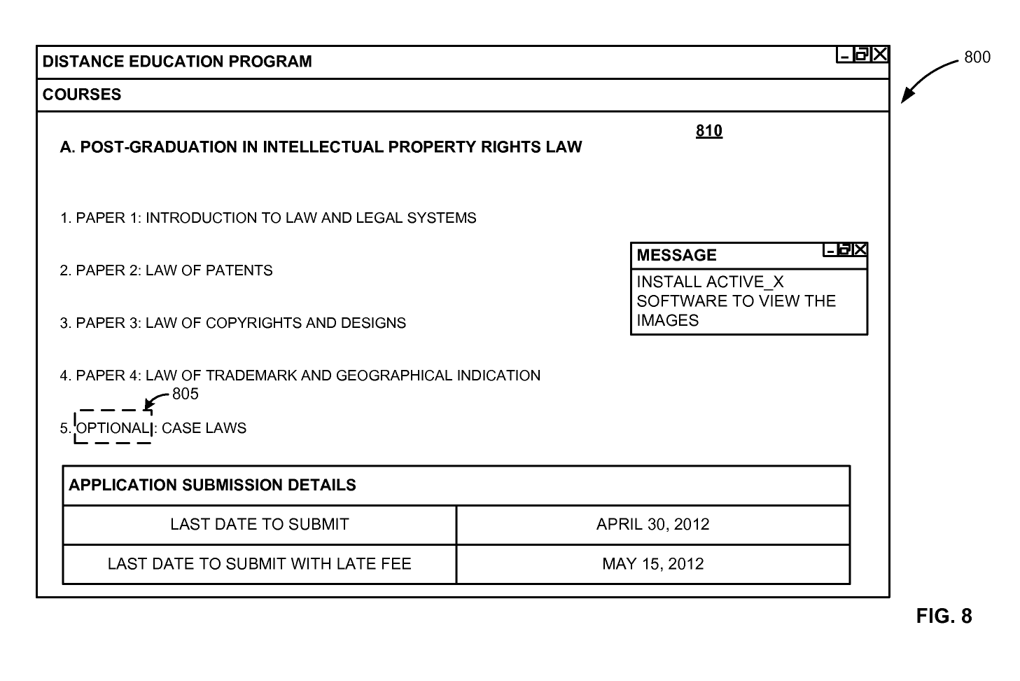

In the example, the OTR UI element display specification table 700 is accessed during runtime to retrieve the user specific element label (e.g., ‘optional’) corresponding to the UI element label (e.g., ‘paper 5’ 430) when the user (e.g., PQR) request for rendering the UI. Further, the UI element label ‘paper 5’ 430 is configured in the suite component ‘LSOFE’, the application component ‘CA’ and the development component ‘LSO_FRONTEND_WDUI’. The UI 400 with configured UI element label ‘paper 5’ 230 is depicted in FIG. 8.

FIG. 8 shows an exemplary user interface 800 illustrating a configured UI element label corresponding to the UI element label of FIG. 4, according to an embodiment. During runtime, an associated UI element display specification table (e.g., OTR element table for the UI element label ‘paper 5’ associated with the user PQR of FIG. 7) is accessed and accordingly the UI element label ‘paper 5’ is configured to user specific element label ‘optional’ 805 in a portion 810 for the user PQR. Further, the UI element label ‘paper 5’ is configured in a suite component ‘LSOFE’, an application component ‘CA’ and a development component ‘LSO_FRONTEND_WDUI’ as per the OTR UI element display specification table 700 of FIG. 7. Therefore, the element display specification tables (e.g., the OTR UI element display specification table 500 of FIG. 5 and the OTR UI element display specification table 700 of FIG. 7) are specific to the users. For example, when the user XYZ request to render the UI, the OTR UI element display specification table 500 of FIG. 5 is accessed and when the user PQR request to render the UI, the OTR UI element display specification table 700 of FIG. 7 is accessed.

FIG. 9 shows an exemplary UI 900 illustrating configuration of a UI element display specification table, according to an embodiment. An authorized person designated to assign access to users is provided an option to provide details to configure UI element label display specification table (e.g., OTR UI element display specification table 500 of FIG. 5 and OTR UI element display specification table 700 of FIG. 7). The UI 500 includes name of the user (e.g., user 905, XYZ) as the UI element display specification table (e.g., OTR UI element display specification table 500 of FIG. 5) is specific to the user (e.g., XYZ).

In one exemplary embodiment, an option to input the UI element label which has to be configured is provided (e.g., UI element label 910). In response, a unique identifier corresponding to the UI element label 910 is displayed (e.g., OTR ID 915). For example, for the UI element label 910 ‘paper 5’, a corresponding OTR ID 915 (e.g., LSO_FRONTEND/PAPER_5) is displayed. Further the OTR ID 915 defines the UI element display specification table (e.g., OTR UI element label) associated with the UI element label (e.g., paper 5).

In one embodiment, the UI 900 provides an option to provide the user specific element label (e.g., 930B, 935B and 940B) for the UI element label 910 (e.g., paper 5) at different levels of component hierarchy at which the UI element label 910 is configured. For example, the level of component hierarchy may include, but is not limited to a suite component 930A (e.g., LSOFE), an application component 935A (e.g., CA) and an access defining component 940A (e.g., LSO_FRONTEND_WDUI). Also, language 925 in which the user specific element label 910 is provided is displayed. In one exemplary embodiment, different user specific element labels (e.g., 930B, 935B and 940B) may be assigned to different level of component hierarchy (e.g., 930A, 935A and 940A). Furthermore, the date on which the UI element label is created (e.g., 945) and the date on which the UI element label is last configured (e.g., 950) are displayed in the UI 900.

Thereby the users maintain user specific UI element display specification tables for different types of UI element (e.g., OTR texts, data elements and alert messages), which they would prefer to configure. Since there is flexibility for the users to maintain the user specific element labels at different levels of component hierarchy, users have wide range of options at which level they want to configure the UI element labels. Further, users can maintain their own UI element display specification tables for configuring the UI element labels without incurring extra cost and including great flexibility.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

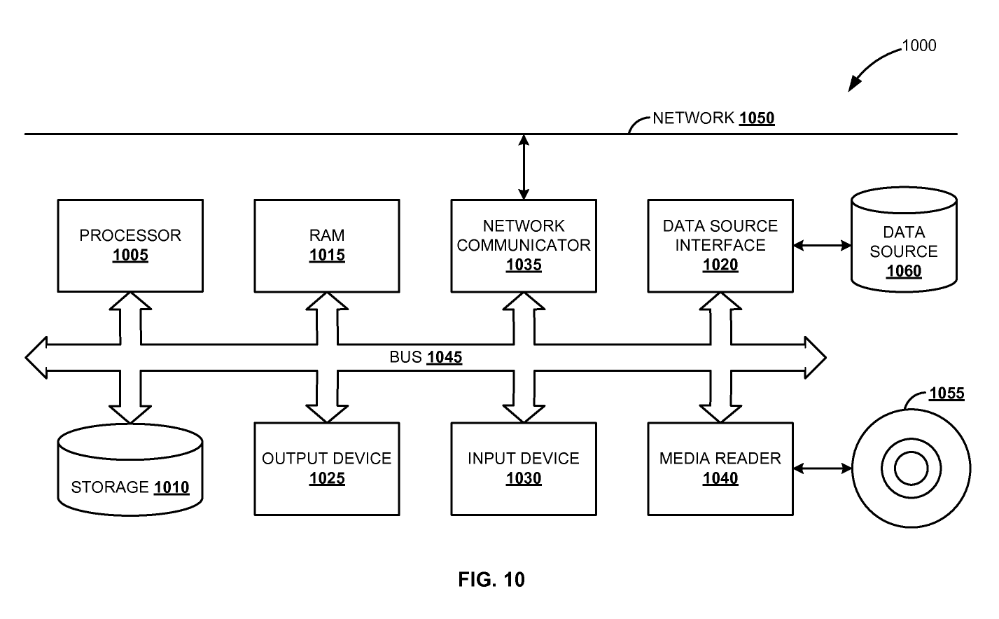

FIG. 10 is a block diagram of an exemplary computer system 1000, according to an embodiment. The computer system 1000 includes a processor 1005 that executes software instructions or code stored on a computer readable storage medium 1055 to perform the above-illustrated methods. The computer system 1000 includes a media reader 1040 to read the instructions from the computer readable storage medium 1055 and store the instructions in storage 1010 or in random access memory (RAM) 1015. The storage 1010 provides a large space for keeping static data where at least some instructions could be stored for later execution. The stored instructions may be further compiled to generate other representations of the instructions and dynamically stored in the RAM 1015. The processor 1005 reads instructions from the RAM 1015 and performs actions as instructed. According to one embodiment, the computer system 1000 further includes an output device 1025 (e.g., a display) to provide at least some of the results of the execution as output including, but not limited to, visual information to users and an input device 1030 to provide a user or another device with means for entering data and/or otherwise interact with the computer system 1000. Each of these output devices 1025 and input devices 1030 could be joined by one or more additional peripherals to further expand the capabilities of the computer system 1000. A network communicator 1035 may be provided to connect the computer system 1000 to a network 1050 and in turn to other devices connected to the network 1050 including other clients, servers, data stores, and interfaces, for instance. The modules of the computer system 1000 are interconnected via a bus 1045. Computer system 1000 includes a data source interface 1020 to access data source 1060. The data source 1060 can be accessed via one or more abstraction layers implemented in hardware or software. For example, the data source 1060 may be accessed by network 1050. In some embodiments the data source 1060 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, are described herein for illustrative purposes, various equivalent modifications are possible within the scope of the one or more embodiments, as those skilled in the relevant art will recognize. These modifications can be made in light of the above detailed description. Rather, the scope is to be determined by the following claims, which are to be interpreted in accordance with established doctrines of claim construction.

What is claimed is:

1. An article of manufacture including a tangible computer readable storage medium to physically store instructions, which when executed by a computer, cause the computer to:
receive a request to render a user interface (UI) element;
retrieve a user specific UI display specification for the UI element label specifying a display configuration of the UI element label at a plurality of hierarchical software component levels;
determine a current hierarchical level of software component associated with the request to render the UI element label; and
based on determining the current hierarchical level of software component, display the UI element label according to the user specific UI display specification.

2. The article of manufacture of claim 1, wherein the user specific UI display specification is stored in a UI element display specification table specific to a user.

3. The article of manufacture of claim 2, wherein the UI element display specification table is stored in an in-memory computing database.

4. The article of manufacture of claim 2, wherein the UI element display specification table is identified using a unique identifier of the UI element label.

5. The article of manufacture of claim 4, wherein the unique identifier of the UI element label is defined by a type of the UI element label including one of an online text repository (OTR) text, a data element and an alert message.

6. The article of manufacture of claim 5, wherein the OTR text, the data element text and the alert message text include corresponding UI element display specification tables.

7. The article of manufacture of claim 1, wherein the plurality of hierarchical software component levels comprises a suite component level, an application component level and an access defining component level.

8. The article of manufacture of claim 1, wherein the user specific UI display specification is provided by an authorized person.

9. A computer implemented method to configure user interface (UI) element label, the method comprising:
receiving a request to render the UI element label;
retrieving a user specific UI display specification for the UI element label specifying a display configuration of the UI element label at a plurality of hierarchical software component levels;
determining a current hierarchical level of software component associated with the request displaying the UI element label; and
based on determining the current hierarchical level of software component, displaying the UI element label according to the user specific UI display specification.

10. The computer implemented method of claim 9, wherein the user specific UI display specification is stored in a UI element display specification table specific to a user.

11. The computer implemented method of claim 10, wherein the UI element display specification table is stored in an in-memory computing database.

12. The computer implemented method of claim 10, wherein the UI element display specification table is identified using a unique identifier of the UI element label.

13. The computer implemented method of claim 12, wherein the unique identifier of the UI element label is defined by a type of the UI element label including one of an online text repository (OTR) text, a data element and an alert message.

14. The computer implemented method of claim 13, wherein the OTR text, the data element text and the alert message text include corresponding UI element display specification tables.

15. The computer implemented method of claim 9, wherein the plurality of hierarchical software component levels comprises a suite component level, an application component level and an access defining component level.

16. The computer implemented method of claim 9, wherein the user specific UI display specification is provided by an authorized person.

17. A computer system to configure a user interface (UI) element label, the computer system comprising a processor, the processor communicating with one or more memory devices storing instructions to:
receive a request to render the UI element label;
retrieve a user specific UI display specification for the UI element label specifying a display configuration of the UI element label at a plurality of hierarchical software component levels, wherein the user specific UI display specification is stored in a UI element display specification table and identified using a unique identifier of the UI element label;
determine a current hierarchical level of software component associated with the request displaying the UI element label, wherein the current hierarchical level of software component comprises a suite component level, an application component level and an access defining component level; and
based on determining the current hierarchical level of software component, display the UI element label according to the user specific UI display specification.

18. The computer system of claim 17, wherein the UI element display specification table is specific to a user.

19. The computer system of claim 17, wherein the unique identifier of the UI element label is defined by a type of the UI element label including one of an online text repository (OTR) text, a data element and an alert message.

20. The computer system of claim 17, wherein the user specific UI display specification is provided by an authorized person.
